(19) United States
(12) Patent Application Publication
(10) Pub. No.: US 2008/0222268 A1
(43) Pub. Date: Sep. 11, 2008

(54) WEB SERVER, METHOD OF CONTROLLING OPERATION THEREOF, AND CONTROL PROGRAM

(76) Inventors: Takashi MIYAMOTO, Asaka-shi (JP); Toshimitsu Fukushima, Asaka-shi (JP)

Correspondence Address: BIRCH STEWART KOLASCH & BIRCH, PO BOX 747, FALLS CHURCH, VA, 22040-0747, US

(21) Appl. No.: 12/041,867

(22) Filed: Mar. 4, 2008

(30) Foreign Application Priority Data
Mar. 5, 2007 (JP) 2007-053591

(51) Int. Cl. G06F 15/16

(52) U.S. Cl. 709/217

(57) ABSTRACT

A web page is displayed comparatively quickly. To achieve this, a web page in which a plurality of link destinations have been embedded by items of hot text is displayed on the display screen of a terminal device in response to a web server being accessed by the terminal device. A web page having a high likelihood of being selected next from among the web pages at the link destinations specified by the items of hot text is decided based upon an access log. The web page thus decided is generated ahead of time. If a request for this previously generated web page arrives at the web server, the previously generated web page data is transmitted from the web server to the terminal device. If a request for web page data that has not been generated in advance arrives at the web server, then the web server generates the web page data in accordance with the request and transmits the web page data to the terminal device.

### BACKGROUND OF THE INVENTION

1. Field of the Invention

This invention relates to a web server, a method of controlling the web server and a program for controlling the web server.

2. Description of the Related Art

There are instances where a plurality of link destinations are embedded in a web page. If a web page in which a plurality of link destinations have been embedded is being displayed and any link destination among these link destinations is clicked, the web page at this link destination will be displayed. If the web page at the link destination is one generated after the link destination is clicked, it takes time for the web page at the link destination to be generated and it takes time for the web page to be displayed.

There is prior art in which distributed content is changed depending upon dynamically changing information, such as communication speed and position information, at a terminal device (Japanese Patent Application Laid-Open No. 2002-236641); prior art that generates and distributes content in which the order of display of items in a menu changes dynamically in conformity with the frequency at which content is accessed (Japanese Patent Application Laid-Open No. 2002-342369); prior art in which a large amount of content is laid out again based upon the viewing tendencies of a user, or in which the dynamic generation of a portal site is performed if such content has been laid out again (Japanese Patent Application Laid-Open No. 2004-5309); and prior art for generating a content reproduction pattern based upon user information and transmitting the generated reproduction pattern to a display unit (Japanese Patent Application Laid-Open No. 2004-78820).

In all of these cases, however, often the web page at a link destination cannot be displayed comparatively quickly.

### SUMMARY OF THE INVENTION

Accordingly, an object of the present invention is to display the web page of a link destination comparatively quickly.

According to the present invention, the foregoing object is attained by providing a web server comprising: a first web page data transmitting device, which is responsive to an initial request supplied from a terminal device, for transmitting requested web page data representing a requested web page in which a plurality of link destinations have been embedded to the terminal device; a first predicted-destination web page data generating device, responsive to the initial request supplied from the terminal device, for generating data representing a first predicted-destination web page, which is a predicted link destination that has been selected a large number of times from among the plurality of link destinations that have been embedded in the request web page, after the request web page is displayed; a predicted-destination web page data transmitting device, responsive to a request for the predicted link destination from the terminal device, for transmitting data representing the predicted-destination web page generated by the first predicted-destination web page data generating device to the terminal device; a non-predicted-destination web page data generating device, responsive to a request from the terminal device for a non-predicted link destination that is a link destination other than the predicted link destination among the plurality of link destinations, for generating non-predicted-destination web page data representing a non-predicted-destination web page at the non-predicted link destination; and a non-predicted-destination web page data transmitting device for transmitting the non-predicted-destination web page data generated by the non-predicted-destination web page data generating device to the terminal device.

The present invention also provides an operation control method suited to the above-described web server. Specifically, the present invention provides a method of controlling operation of a web server, comprising the steps of: in response to an initial request supplied from a terminal device, transmitting to the terminal device, by a first web page data transmitting device, requested web page data representing a requested web page in which a plurality of link destinations have been embedded; in response to the initial request supplied from the terminal device, generating, by a first predicted-destination web page data generating device, data representing a first predicted-destination web page, which is a predicted link destination that has been selected a large number of times from among the plurality of link destinations that have been embedded in the request web page, after the request web page is displayed; in response to a request for the predicted link destination from the terminal device, transmitting to the terminal device, by a predicted-destination web page data transmitting device, data representing the predicted-destination web page generated by the first predicted-destination web page data generating device; in response to a request from the terminal device for a non-predicted link destination that is a link destination other than the predicted link destination among the plurality of link destinations, generating, by a non-predicted-destination web page data generating device, non-predicted-destination web page data representing a non-predicted-destination web page at the non-predicted link destination; and transmitting to the terminal device, by a non-predicted-destination web page data transmitting device, the non-predicted-destination web page data generated by the non-predicted-destination web page data generating device.

The present invention also provides a program for implementing the method of controlling the web server, as well as a recording medium on which this program has been stored.

In accordance with the present invention, when an initial request is supplied from a terminal device, data representing the requested web page is transmitted from a web server to the terminal device. The web page (requested web page) is displayed on the display screen of the terminal device. A plurality of link destinations have been embedded in the request web page. Since a link destination (predicted link destination) selected a large number of times from among the plurality of link destinations is construed to be one having a high likelihood of being selected, data representing a web page (predicted-destination web page) at a predicted link destination that has been selected a large number of times is generated ahead of time in response to the application of the initial request.

When there is a request from the terminal device for a predicted link destination, the predicted-destination web page data generated ahead of time is transmitted from the web server to the terminal device. If a request from the terminal device is not for a predicted link destination but is a request for non-predicted link destination, data representing the web page (non-predicted-destination web page) at this non-predicted link destination is generated and the generated non-predicted destination web page data is transmitted from the web server to the terminal device.

Thus, web page data having a high likelihood of being selected next is generated beforehand in response to application of the initial request. Therefore, if there is a request for this web page having a high likelihood of being selected, the web page data of this web page can be transmitted to the terminal device immediately. The web page at the selected link destination can thus be transmitted comparatively quickly.

The first predicted-destination web page data generating device may generate data representing a predicted-destination web page in which a plurality of link destinations have been embedded. In this case, the web server preferably further comprises a second predicted-destination web page data generating device, responsive to an initial request supplied from the terminal device, for generating data representing a second predicted-destination web page, which is a link destination that has been selected a large number of times from among the plurality of link destinations that have been embedded in the predicted-destination web page, after the predicted-destination web page is displayed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates examples of web pages;

FIG. 2 illustrates a hierarchical structure of web pages;

FIGS. 3A and 3B illustrate hierarchical structures of web pages;

FIG. 4 is a block diagram illustrating the electrical configuration of a web server;

FIG. 5 is a flowchart illustrating processing executed by a terminal device and web server;

FIG. 6 illustrates a hierarchical structure of web pages;

FIGS. 7A and 7B illustrate hierarchical structures of web pages; and

FIG. 8 is a flowchart illustrating processing executed by a terminal device and web server.

### DESCRIPTION OF THE PREFERRED EMBODIMENTS

Preferred embodiments of the present invention will now be described in detail with reference to the accompanying drawings.

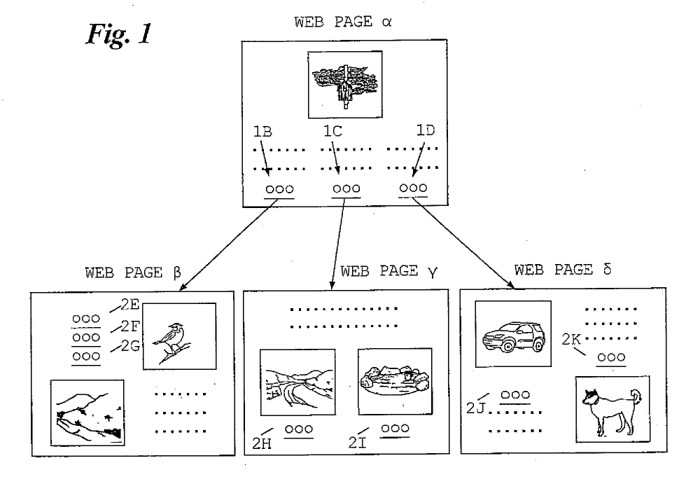

FIG. 1 illustrates web pages displayed on the display screen of a terminal device such as a client computer or mobile telephone.

A web page α contains a still picture, a moving picture and text, etc. The web page α is linked to web pages β, γ and δ. The web page α contains items of hot text 1B, 1C and 1D for selecting a plurality of link destinations.

If the hot text 1B contained on web page α is clicked, the web page β linked by the hot text 1B is displayed on the display screen of the terminal device. The web page β is further linked to other web pages and contains hot text 2E, 2F and 2G for selecting a plurality of link destinations.

If the hot text 1C contained on web page α is clicked, the web page γ linked by the hot text 1C is displayed on the display screen of the terminal device. This web page also contains hot text 2H and 2I for selecting a plurality of link destinations.

If the hot text 1D contained on web page α is clicked, the web page δ linked by the hot text 1D is displayed on the display screen of the terminal device. This web page also contains hot text 2J and 2K for selecting a plurality of link destinations.

This embodiment according to the present invention is such that when a web page in which a plurality of link destinations have been embedded is displayed, the web page of the next link destination is displayed comparatively quickly.

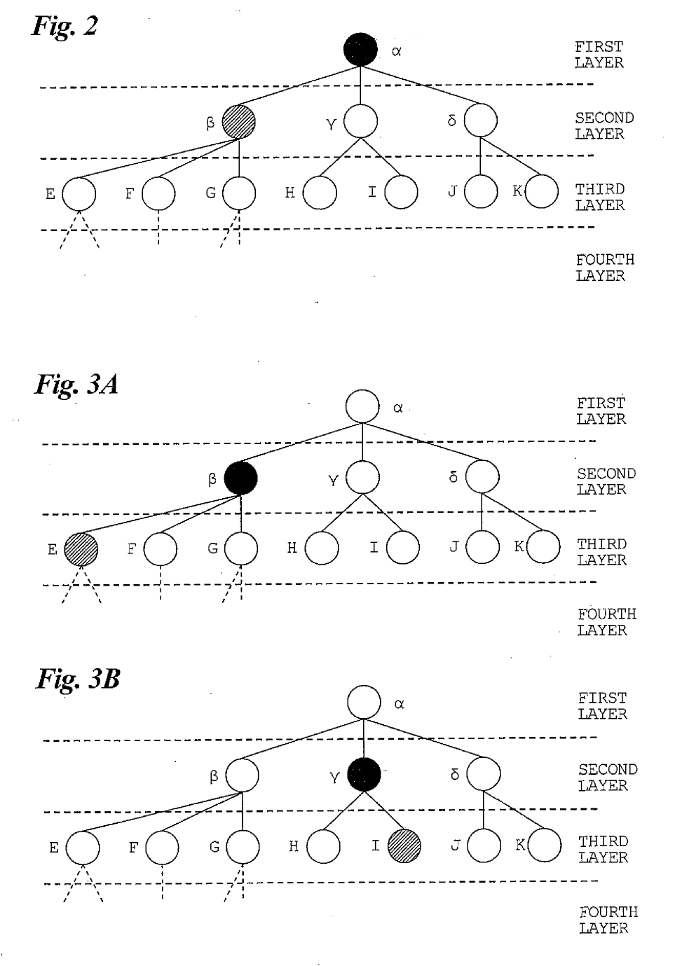

FIG. 2 illustrates the hierarchical structure of web pages.

The above-mentioned web page α is positioned as a web page of a first layer. Accordingly, the web pages β, γ and δ linked to the web page α can be positioned as web pages of a second layer. If web pages E, F and G are further linked to the web page β, web pages H and I are further linked to the web page γ and web pages J and K are further linked to web page δ, then the web pages E to K can be positioned as web pages of a third layer. Furthermore, if there are web pages linked to these web pages E to K, these linked web pages will be web pages of a fourth layer.

If the user requests the web page α in the first layer (the requested web page is indicated by the black circle and shall be referred to as the “requested web page”), data representing the web page α is transmitted to the terminal device of the user in-response to this request and the web page α is displayed on the display screen of the user's terminal device, as described above. Further, from among the web pages β, γ, δ in the layer underlying the layer of the web page α, web page data for displaying web page β (referred to as a “predicted-destination web page, which is indicated by the hatching), which has a high probability of being viewed next by the user whose viewed the web page α, is generated in advance of a request from the user. If the web page β is then requested by the user, the web page data for displaying the web page β can be transmitted to the terminal device of the user rapidly and the web page β can be displayed quickly.

FIGS. 3A and 3B also illustrate the hierarchical structures of web pages. FIG. 3A illustrates a case where after the web page α has been viewed, web page β, which has a high probability of being viewed next, has been requested. FIG. 3B illustrates a case where after the web page α has been viewed, a web page (referred to as a “non-predicted-destination web page”) other than the web page β having a high probability of being viewed next has been selected.

With reference to FIG. 3A, in a case where the predicted-destination web page β has been requested after the viewing of the web page α, web page data representing the web page β that has been generated beforehand in response to the request for the web page α is transmitted to the terminal device of the user. Also generated is web page data for displaying web page E, which has a high probability of being viewed next by the user who viewed the web page β. In a case where the user who viewed the web page β has requested the viewing of the web page E next, the data representing the web page B can be transmitted to the terminal device of the user quickly.

With reference to FIG. 3B, in a case where the non-predicted-destination web page γ has been requested after the viewing of the web page α, data representing the web page γ is generated in response to this request because the data representing the web page γ has not been generated beforehand. The generated web page data is transmitted to the terminal device of the user. If there is a request for the web page γ, data representing web page I, which has a high probability of being viewed next by the user who viewed the web page γ, is generated in advance.

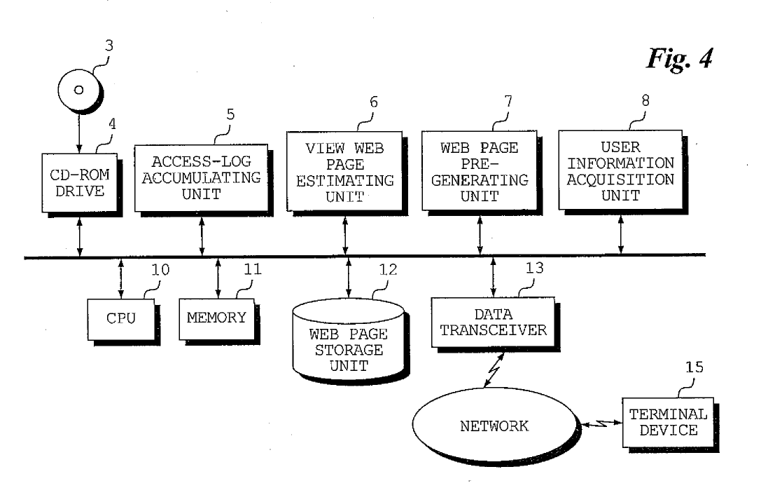

FIG. 4 is a block diagram illustrating the electrical configuration of the web server for generated the above-described web page data. A terminal device 15 of the user also is illustrated in FIG. 4.

The operation of the overall web server is controlled by a CPU 10. The web server includes a CD-ROM (compact disk-read-only memory) drive 4. If a CD-ROM 3 storing an operation program for controlling operation (described later) is loaded in the CD-ROM drive 4, the operation program that has been stored on the CD-ROM 3 is read. The read operation program is installed in the web server. The web server further includes a memory 11 for storing data temporarily.

The web server includes an access-log accumulating unit 5. In a case where a web page in the next layer from the layer of the requested web page has been viewed, as described above, the access-log accumulating unit 5 accumulates and stores, on a per-web-page basis, the number of times a web page of the next layer has been viewed. On the basis of the number of view events that has been stored in the access-log accumulating unit 5, a view web page estimating unit 6 predicts (estimates) the web page that will probably be viewed next. Data representing the predicted web page is generated in a web page pre-generating unit 7. The web page data generated in the web page pre-generating unit 7 is stored in a web page storage unit 12.

The web server further includes a user information acquisition unit 8. The latter is a unit for acquiring information regarding the terminal device 15 of the user who accessed the web server. A web page suitable for display by the terminal device 15 of the user can be generated. The web server further includes a data transceiver 13 for sending and receiving data to and from the terminal device 15 of the user via a network.

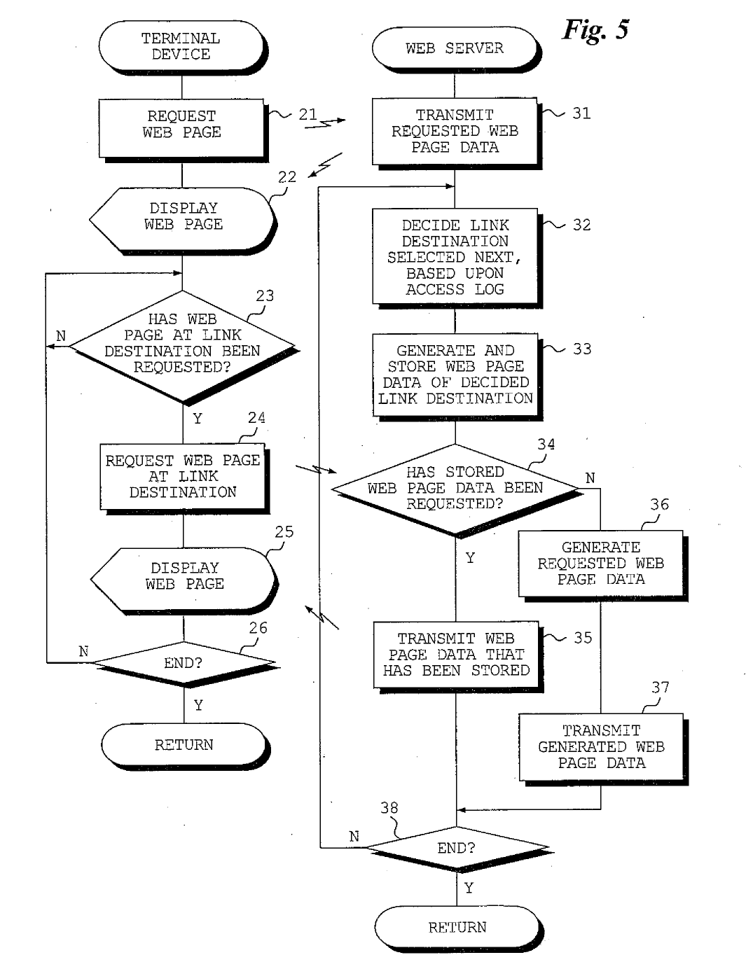

FIG. 5 is a flowchart illustrating processing for communication between the terminal device of the user and the web server.

The terminal device 15 accesses the web server and issues a request (referred to as an “initial request”) for a desired web page (step 21). In response to the request, web page data (the requested web page) is transmitted from the web server to the terminal device 15 (step 31). When the web page data transmitted from the web server is received by the terminal device 15, the web page represented by this received web page data is displayed on the display screen of the terminal device 15 (step 22). It goes without saying that a plurality of link destinations have been embedded in this web page, as described above.

When the web page is requested by the terminal device, the requested web page data is transmitted from the web server to the terminal device 15, as indicated at step 31. In addition, the web page (referred to as a “first predicted-destination web page”) at the link destination (predicted link destination) having a high probability of being viewed next is decided, based upon the number of view events that has been stored in the access-log accumulating unit 5, from among web pages at the link destinations that have been embedded in the requested web page (i.e., web pages in the layer underlying that of the requested web page) (step 32). Data representing the web page at the decided link destination is generated in the web page pre-generating unit 7 and is then stored in the web page storage unit 12 (step 33).

The requested web page is displayed on the display screen of the terminal device, and request data requesting a web page at any link destination among the link destinations that have been embedded in the requested web page is transmitted from the terminal device 15 to the web server (“YES” at step 23; step 24).

When the request data transmitted from the terminal device 15 is received at the web server, it is determined whether the request represented by the received request data is a request regarding web page data generated ahead of time (data representing a first predicted-destination web page) (step 34). If the request regards web page data generated in advance, then this previously generated web page data is transmitted from the web server to the terminal device 15 (step 35). If the request is not a request for web page data generated ahead of time (“NO” at step 34), then data representing the requested web page (data representing a non-predicted-destination web page) is generated in the web page pre-generating unit 7 (step 36). Of course, it may be so arranged that the web page pre-generating unit 7 is used in order to generate a web page in advance and a web page generated immediately in response to a request is generated using another device. The web page data generated is transmitted from the web server to the terminal device 15 (step 37). It goes without saying that the access log stored in the access-log accumulating unit 5 is updated in accordance with the requested web page.

When the web page data that has been transmitted from the web server is received at the terminal device, the web page represented by the received web page data is displayed on the display screen of the terminal device (step 25). When the web page data that has been generated in advance by the web server is transmitted from the web server, this web page data is transmitted to the terminal device 15 as soon as it is requested. As a result, the web page is displayed promptly.

The processing of steps 23 to 25 and the processing of steps 32 to 37 is repeated until the request for a web page ends (steps 26, 38).

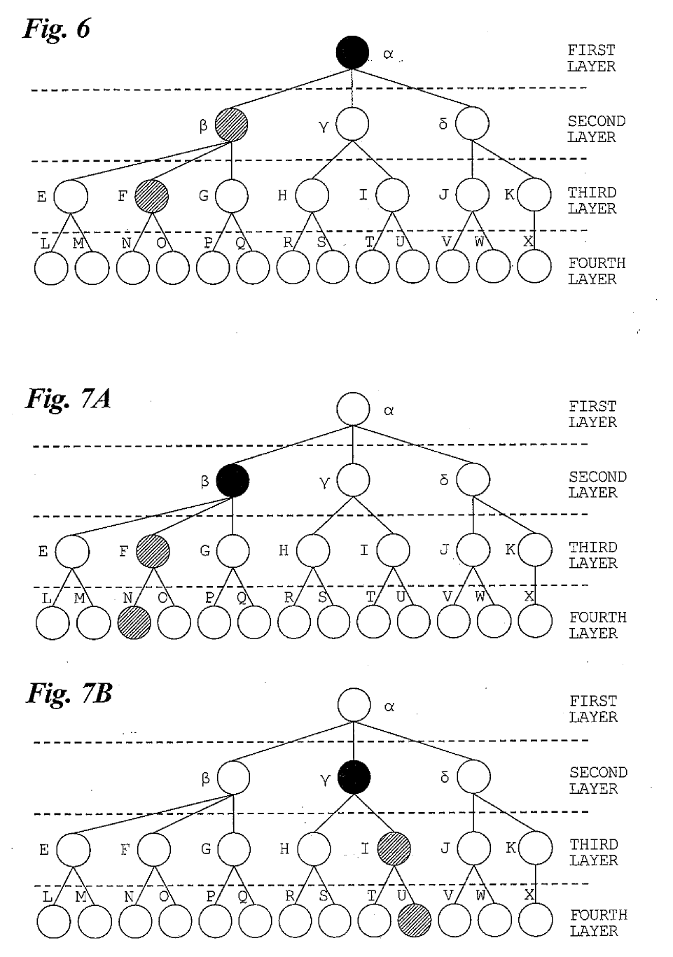

FIGS. 6 to 8 illustrate another embodiment of the present invention.

In the embodiment described above, data representing a web page, which is a link destination, in a layer immediately following that of the requested web page is generated. In the embodiment illustrated next, however, when a web page is requested, not only data representing a web page in the next layer but also data representing a web page in the layer following the next layer is generated.

FIG. 6 illustrates the hierarchical structure of web pages and corresponds to FIG. 2.

If the web page α indicated by the black circle is requested, data representing the web page β (first predicted-destination web page), which has a high probability of being viewed next among the web pages β, γ and δ that are the link destinations of the web page α, is generated. Further, in this embodiment, if the web page α is requested, web page data representing web page F (referred to-as a “second predicted-destination web page”), which has a high probability of being requested next in a case where web page β has been requested, is generated as well. Thus, data representing a web page in the layer that follows that of the requested web page and data representing a web page in the layer that follows this layer is generated.

FIGS. 7A and 7B also illustrate the hierarchical structures of web pages and correspond to FIGS. 3A and 3B, respectively. Here web pages L to X have been defined in a fourth layer.

With reference to FIG. 7A, it is assumed that web page β has been requested after a request for web page α. Accordingly, as described above, data representing the web page β that has been generated ahead of time is transmitted from the web server to the terminal device. Further, data representing web page N having a high probability of being viewed next following web page F having a high probability of being viewed next by the user who viewed web page β is generated as well (the data representing the web page F is data that was generated when the web page α was requested).

With reference to FIG. 7B, If web page γ for which data has not been generated ahead of time is requested after web page α is requested, data representing web page I having a high likelihood of being viewed following web page 65 and data representing web page U having a high likelihood of being viewed following web page I is generated.

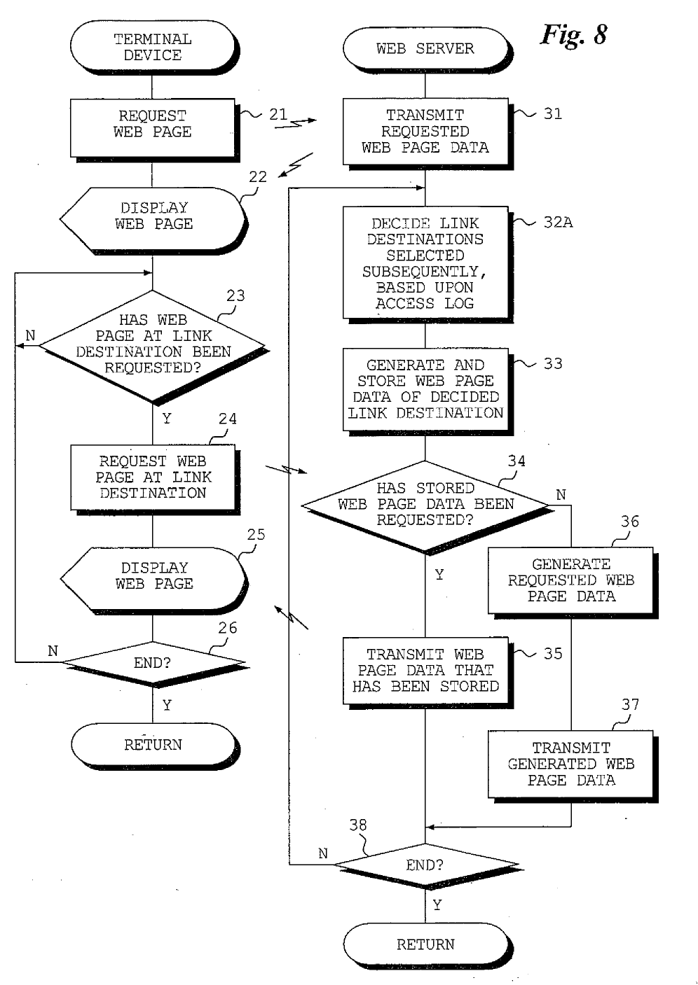

FIG. 8 is a flowchart illustrating processing executed by the terminal device and web server according to this embodiment. Processing steps in FIG. 8 identical with those shown in FIG. 5 are designated by like step numbers.

As described above, the terminal device 15 issues a request for a web page to the web server (step 21). Web page data conforming to the request is transmitted from the web server to the terminal device 15 (step 31). Link destinations having high probabilities of being selected in layers that follow that of the requested web page (link destinations up to those two underlying layers ahead, as described above) are decided (step 32A). Data representing each of the web pages of the link destinations up to the two decided link destinations ahead is generated and stored (step 33).

If a request for web page data that has been stored in the web server arrives (“YES” at step 34), then the web page data stored in advance is transmitted from the web server to the terminal device (step 35). If a request for web page data that is different from web page data that has been stored beforehand in the web server (“NO” at step 34), then the requested web page data is generated (step 36) and the generated web page data is transmitted from the web server to the terminal device (step 37). If the request for a web page has not ended (“NO” at step 38), then web pages having high probabilities of being selected the next two times (web pages up to those two link destinations ahead) are again decided and generated (steps 32A, 33).

In this embodiment, web pages up to those two link destinations ahead are generated in advance. However, it may be so arranged that web pages even further ahead are generated. Further, although each of the devices in the foregoing embodiments are implemented by hardware, it may be so arranged that they are implemented by software.

As many apparently widely different embodiments of the present invention can be made without departing from the spirit and scope thereof, it is to be understood that the invention is not limited to the specific embodiments thereof except as defined in the appended claims.

What is claimed is:

1. A web server comprising:
a first web page data transmitting device, which is responsive to an initial request supplied from a terminal device, for transmitting requested web page data representing a requested web page in which a plurality of link destinations have been embedded to the terminal device;
a first predicted-destination web page data generating device, responsive to the initial request supplied from the terminal device, for generating data representing a first predicted-destination web page, which is a predicted link destination that has been selected a large number of times from among the plurality of link destinations that have been embedded in the request web page, after the request web page is displayed;
a predicted-destination web page data transmitting device, responsive to a request for the predicted link destination from the terminal device, for transmitting data representing the predicted-destination web page generated by said first predicted-destination web page data generating device to the terminal device;
a non-predicted-destination web page data generating device, responsive to a request from the terminal device for a non-predicted link destination that is a link destination other than the predicted link destination among the plurality of link destinations, for generating non-predicted-destination web page data representing a non-predicted-destination web page at the non-predicted link destination; and
a non-predicted-destination web page data transmitting device for transmitting the non-predicted-destination web page data generated by said non-predicted-destination web page data generating device to the terminal device.

2. The web server according to claim 1, wherein said first predicted-destination web page data generating device generates data representing a predicted-destination web page in which a plurality of link destinations have been embedded;
said web server further comprising a second predicted-destination web page data generating device, responsive to an initial request supplied from the terminal device, for generating data representing a second predicted-destination web page, which is a link destination that has been selected a large number of times from among the plurality of link destinations that have been embedded in the predicted-destination web page, after the predicted-destination web page is displayed.

3. A method of controlling operation of a web server, comprising the steps of:
in response to an initial request supplied from a terminal device, transmitting to the terminal device, by a first web page data transmitting device, requested web page data representing a requested web page in which a plurality of link destinations have been embedded;
in response to the initial request supplied from the terminal device, generating, by a first predicted-destination web page data generating device, data representing a first predicted-destination web page, which is a predicted link destination that has been selected a large number of times from among the plurality of link destinations that have been embedded in the request web page, after the request web page is displayed;
in response to a request for the predicted link destination from the terminal device, transmitting to the terminal device, by a predicted-destination web page data transmitting device, data representing the predicted-destination web page generated by the first predicted-destination web page data generating device;
in response to a request from the terminal device for a non-predicted link destination that is a link destination other than the predicted link destination among the plurality of link destinations, generating, by a non-predicted-destination web page data generating device, non-predicted-destination web page data representing a non-predicted-destination web page at the non-predicted link destination; and
transmitting to the terminal device, by a non-predicted-destination web page data transmitting device, the non-predicted-destination web page data generated by the non-predicted-destination web page data generating device.

4. A program for controlling a web server, said program comprising the processing steps of:
in response to an initial request supplied from a terminal device, transmitting requested web page data, which represents a requested web page in which a plurality of link destinations have been embedded, to the terminal device;
in response to the initial request supplied from the terminal device, generating data representing a first predicted-destination web page, which is a predicted link destination that has been selected a large number of times from among the plurality of link destinations that have been embedded in the request web page, after the request web page is displayed;
in response to a request for the predicted link destination from the terminal device, transmitting data representing the generated predicted-destination web page to the terminal device;
in response to a request from the terminal device for a non-predicted link destination that is a link destination other than the predicted link destination among the plurality of link destinations, generating non-predicted-destination web page data representing a non-predicted-destination web page at the non-predicted link destination; and
transmitting the generated non-predicted-destination web page data to the terminal device.

5. A recording medium on which the program set forth in claim 4 has been stored.
